(19) United States
(12) Patent Application Publication
(10) Pub. No.: US 2026/0278453 A1
(43) Pub. Date: Sep. 17, 2026

(54) SELECTING MACHINE LEARNING MODELS FOR TASKS USING A REGRESSION MODEL

(71) Applicant: International Business Machines Corporation, Armonk, NY (US)

(72) Inventors: Lukasz G. Cmielowski, Krakow (PL); Jakub Walaszczyk, Czeladz (PL); Daniel Jakub Ryszka, Krakow (PL); Dorota Laczak, Mielec (PL)

(21) Appl. No.: 19/078,557

(22) Filed: Mar. 13, 2025

(51) Int. Cl. G06N 20/00

(52) U.S. Cl. CPC G06N 20/00

(57) ABSTRACT

A computer-implemented method is provided. A processor set receives a benchmark dataset comprising a number of benchmark records for evaluating a number of machine learning models. The processor set creates a number of prompts for the number of machine learning models based on a subset of benchmark records from the number of benchmark records. The processor set retrieves a number of outputs for each machine learning model by inputting the number of prompts to each machine learning model from the number of machine learning models. The processor set determines a performance score for each machine learning model based on correctness for the number of outputs for each machine learning model using a regression model. The processor set selects a subset of machine learning models from the number of machine learning models to perform a task based on performance scores for the number of machine learning models.

### BACKGROUND

The disclosure relates generally to selecting machine learning models for tasks using a regression model.

Machine learning models are designed to identify patterns in data and make predictions or decisions without explicit programming. Specifically, machine learning models analyze patterns in data and generalize the patterns to make informed predictions on new, unseen inputs. Machine learning models are widely used in various applications such as fraud detection, recommendation systems, speech recognition, and medical diagnosis.

Large language models are a specialized class of deep learning models designed for natural language processing (NLP) tasks. These models use a transformer-based architecture, which enables them to process and generate human-like text by learning contextual relationships between words or phrases.

Large language models are trained on vast amounts of text data, which allows the large language models to perform a wide range of tasks such as text summarization, translation, and question answering. Unlike traditional models that rely on task-specific training, large language models are pre-trained on large datasets and then fine-tuned for specific applications.

### SUMMARY

According to one illustrative embodiment, a computer-implemented method is provided. A processor set receives a benchmark dataset comprising a number of benchmark records for evaluating a number of machine learning models. The processor set creates a number of prompts for the number of machine learning models based on a subset of benchmark records from the number of benchmark records. The processor set retrieves a number of outputs for each machine learning model from the number of machine learning models by inputting the number of prompts to each machine learning model from the number of machine learning models. Each output from the number of outputs corresponds to a prompt from the number of prompts. The processor set determines a performance score for each machine learning model from the number of machine learning models based on correctness for the number of outputs for each machine learning model from the number of machine learning models using a regression model. The processor set selects a subset of machine learning models from the number of machine learning models to perform a task based on performance scores for the number of machine learning models. According to other illustrative embodiments, a computer system, and a computer program product for generating a compressed dataset are provided.

### BRIEF DESCRIPTION OF THE DRAWINGS

FIG. 1 is a pictorial representation of a computing environment in which illustrative embodiments may be implemented;

FIG. 2 is an illustration of a block diagram of a model management environment in accordance with an illustrative embodiment;

FIG. 3 is an illustration of a table showing evaluations of outputs generated by machine learning models in accordance with an illustrative embodiment;

FIG. 4 is a flowchart of a process for selecting machine learning models for performing tasks in accordance with an illustrative embodiment;

FIG. 5 is a flowchart of a process for determining performance scores for the number of machine learning models in accordance with an illustrative embodiment;

FIG. 6 is a flowchart of a process for ranking machine learning models in accordance with an illustrative embodiment; and

FIG. 7 is a block diagram of a data processing system in accordance with an illustrative embodiment.

### DETAILED DESCRIPTION

A computer implemented method is provided. A processor set receives a benchmark dataset comprising a number of benchmark records for evaluating a number of machine learning models. The processor set creates a number of prompts for the number of machine learning models based on a subset of benchmark records from the number of benchmark records. The processor set retrieves a number of outputs for each machine learning model from the number of machine learning models by inputting the number of prompts to each machine learning model from the number of machine learning models. Each output from the number of outputs correspond to a prompt from the number of prompts. The processor set determines a performance score for each machine learning model from the number of machine learning models based on correctness for the number of outputs for each machine learning model from the number of machine learning models using a regression model. The processor set selects a subset of machine learning models from the number of machine learning models to perform a task based on performance scores for the number of machine learning models. As a result, the illustrative embodiments provide a technical effect of efficiently evaluating machine learning models to determine performance of machine learning models such that the most appropriate machine learning model can be selected for a given task.

In the illustrative embodiments, as part of determining a performance score for each machine learning model from the number of machine learning models using a regression model based on correctness for the number of outputs for each machine learning model from the number of machine learning models, the processor set determines a faithfulness score for each output from the number of outputs for each machine learning model from the number of machine learning models based on correctness of each output. The processor set determines a cumulative score for each output from the number of outputs based on the faithfulness scores for the number of outputs. The processor set trains the regression model using a training dataset comprising cumulative scores determined for the number of outputs. The processor set predicts performance of each machine learning model using the regression model based on all benchmark records from the number of benchmark records. The processor set generates the performance scores for the number of machine learning models based on predicted performances for the number of machine learning models. As a result, the illustrative embodiments provide a technical effect of evaluating machine learning models comprehensively using the regression model with limited amounts of training data.

In the illustrative embodiments, the cumulative score for each output from the number of outputs is determined by obtaining a mean for the cumulative sum of faithfulness scores for each output and faithfulness scores for all outputs precede each output. As a result, the illustrative embodiments provide a technical effect of determining a score that efficiently captures the accuracy of each output generated by the number of machine learning models by also considering the accuracy of all outputs that precede each output.

In the illustrative embodiments, the processor set ranks the number of machine learning models based on the performance scores determined for the number of machine learning models. As a result, the illustrative embodiments provide a technical effect of providing an objective way for comparing different machine learning models using a single scale.

In the illustrative embodiments, the subset of benchmark records is stored in an in-memory vector database that runs entirely in memory. As a result, the illustrative embodiments provide a technical effect of storing data directly in random-access memory (RAM) to reduce latency and improve query performance. By such storage method, operations such as retrieval and search can happen almost instantaneously without delays caused by disk input/output operations.

In the illustrative embodiments, each performance score from the performance scores for the number of machine learning models is a weighted score determined based on predicted performances for a machine learning model and additional input variables associated with the machine learning model. As a result, the illustrative embodiments provide a technical effect of allowing a more balanced and fair assessment of performance for machine learning models by assigning different levels of importance to various relevant factors.

In the illustrative embodiments, the subset of machine learning models are selected for performing tasks associated with Retrieval-Augmented Generation (RAG). As a result, the illustrative embodiments provide a technical effect of ensuring accuracy, efficiency, and relevance in AI-driven responses. Specifically, suitable machine learning models for Retrieval-Augmented Generation (RAG) ensure that the most relevant documents, facts, or contextual information are fetched and effectively synthesized into coherent, meaningful responses.

A computer system comprises a processor set, a set of one or more computer-readable storage media, and program instructions, stored in the set of one or more computer-readable storage media, to cause the processor set to perform the following computer operations. A processor set receives a benchmark dataset comprising a number of benchmark records for evaluating a number of machine learning models. The processor set creates a number of prompts for the number of machine learning models based on a subset of benchmark records from the number of benchmark records. The processor set retrieves a number of outputs for each machine learning model from the number of machine learning models by inputting the number of prompts to each machine learning model from the number of machine learning models. Each output from the number of outputs correspond to a prompt from the number of prompts. The processor set determines a performance score for each machine learning model from the number of machine learning models based on correctness for the number of outputs for each machine learning model from the number of machine learning models using a regression model. The processor set selects a subset of machine learning models from the number of machine learning models to perform a task based on performance scores for the number of machine learning models. As a result, the illustrative embodiments provide a technical effect of efficiently evaluating machine learning models to determine performance of machine learning models such that the most appropriate machine learning model can be selected for a given task.

In the illustrative embodiments, as part of determining a performance score for each machine learning model from the number of machine learning models using a regression model based on correctness for the number of outputs for each machine learning model from the number of machine learning models, the processor set further executes the program instructions to determine a faithfulness score for each output from the number of outputs for each machine learning model from the number of machine learning models based on correctness of each output. The processor set further executes the program instructions to determine a cumulative score for each output from the number of outputs based on the faithfulness scores for the number of outputs. The processor set further executes the program instructions to train the regression model using a training dataset comprising cumulative scores determined for the number of outputs. The processor set further executes the program instructions to predict performance of each machine learning model using the regression model based on all benchmark records from the number of benchmark records. The processor set further executes the program instructions to generate the performance scores for the number of machine learning models based on predicted performances for the number of machine learning models. As a result, the illustrative embodiments provide a technical effect of evaluating machine learning models comprehensively using the regression model with limited amounts of training data.

In the illustrative embodiments, the cumulative score for each output from the number of outputs is determined by obtaining a mean for the cumulative sum of faithfulness scores for each output and faithfulness scores for all outputs precede each output. As a result, the illustrative embodiments provide a technical effect of determining a score that efficiently captures the accuracy of each output generated by the number of machine learning models by also considering the accuracy of all outputs that precede each output.

In the illustrative embodiments, the processor set further executes the program instructions to rank the number of machine learning models based on the performance scores determined for the number of machine learning models. As a result, the illustrative embodiments provide a technical effect of providing an objective way for comparing different machine learning models using a single scale.

In the illustrative embodiments, the subset of benchmark records is stored in an in-memory vector database that runs entirely in memory. As a result, the illustrative embodiments provide a technical effect of storing data directly in random-access memory (RAM) to reduce latency and improve query performance. By such a storage method, operations such as retrieval and search can happen almost instantaneously without delays caused by disk input/output operations.

In the illustrative embodiments, each performance score from the performance scores for the number of machine learning models is a weighted score determined based on predicted performances for a machine learning model and additional input variables associated with the machine learning model. As a result, the illustrative embodiments provide a technical effect of allowing a more balanced and fair assessment of performance for machine learning models by assigning different levels of importance to various relevant factors.

In the illustrative embodiments, the subset of machine learning models are selected for performing tasks associated with Retrieval-Augmented Generation (RAG). As a result, the illustrative embodiments provide a technical effect of ensuring accuracy, efficiency, and relevance in AI-driven responses. Specifically, suitable machine learning models for Retrieval-Augmented Generation (RAG) ensure that the most relevant documents, facts, or contextual information are fetched and effectively synthesized into coherent, meaningful responses.

In the illustrative embodiments, a computer program product is provided. The computer program product comprises a set of one or more computer-readable storage media and program instructions, stored in the set of one or more computer-readable storage media, for causing a processor set to perform the following computer operations. The program instructions are executable by a computer system to receive a benchmark dataset comprising a number of benchmark records for evaluating a number of machine learning models. The program instructions are executable by a computer system to create a number of prompts for the number of machine learning models based on a subset of benchmark records from the number of benchmark records. The program instructions are executable by a computer system to retrieve a number of outputs for each machine learning model from the number of machine learning models by inputting the number of prompts to each machine learning model from the number of machine learning models. Each output from the number of outputs correspond to a prompt from the number of prompts. The program instructions are executable by a computer system to determine a performance score for each machine learning model from the number of machine learning models based on correctness for the number of outputs for each machine learning model from the number of machine learning models using a regression model. The program instructions are executable by a computer system to select a subset of machine learning models from the number of machine learning models to perform a task based on performance scores for the number of machine learning models. As a result, the illustrative embodiments provide a technical effect of efficiently evaluating machine learning models to determine performance of machine learning models such that the most appropriate machine learning model can be selected for a given task.

In the illustrative embodiments, as part of determining a performance score for each machine learning model from the number of machine learning models using a regression model based on correctness for the number of outputs for each machine learning model from the number of machine learning models, the program instructions are further executable by a computer system to determine a faithfulness score for each output from the number of outputs for each machine learning model from the number of machine learning models based on the correctness of each output. The program instructions are further executable by a computer system to determine a cumulative score for each output from the number of outputs based on the faithfulness scores for the number of outputs. The program instructions are further executable by a computer system to train the regression model using a training dataset comprising cumulative scores determined for the number of outputs. The program instructions are further executable by a computer system to predict performance of each machine learning model using the regression model based on all benchmark records from the number of benchmark records. The program instructions are further executable by a computer system to generate the performance scores for the number of machine learning models based on predicted performances for the number of machine learning models. As a result, the illustrative embodiments provide a technical effect of evaluating machine learning models comprehensively using the regression model with limited amounts of training data.

In the illustrative embodiments, the cumulative score for each output from the number of outputs is determined by obtaining a mean for the cumulative sum of faithfulness scores for each output and faithfulness scores for all outputs precede each output. As a result, the illustrative embodiments provide a technical effect of determining a score that efficiently captures the accuracy of each output generated by the number of machine learning models by also considering the accuracy of all outputs that precede each output.

In the illustrative embodiments, the program instructions are further executable by the computer system to rank the number of machine learning models based on the performance scores determined for the number of machine learning models. As a result, the illustrative embodiments provide a technical effect of providing an objective way for comparing different machine learning models using a single scale.

In the illustrative embodiments, the subset of benchmark records is stored in an in-memory vector database that runs entirely in memory. As a result, the illustrative embodiments provide a technical effect of storing data directly in random-access memory (RAM) to reduce latency and improve query performance. By such a storage method, operations such as retrieval and search can happen almost instantaneously without delays caused by disk input/output operations.

In the illustrative embodiments, the subset of machine learning models are selected for performing tasks associated with Retrieval-Augmented Generation (RAG). As a result, the illustrative embodiments provide a technical effect of ensuring accuracy, efficiency, and relevance in AI-driven responses. Specifically, suitable machine learning models for Retrieval-Augmented Generation (RAG) ensure that the most relevant documents, facts, or contextual information are fetched and effectively synthesized into coherent, meaningful responses.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

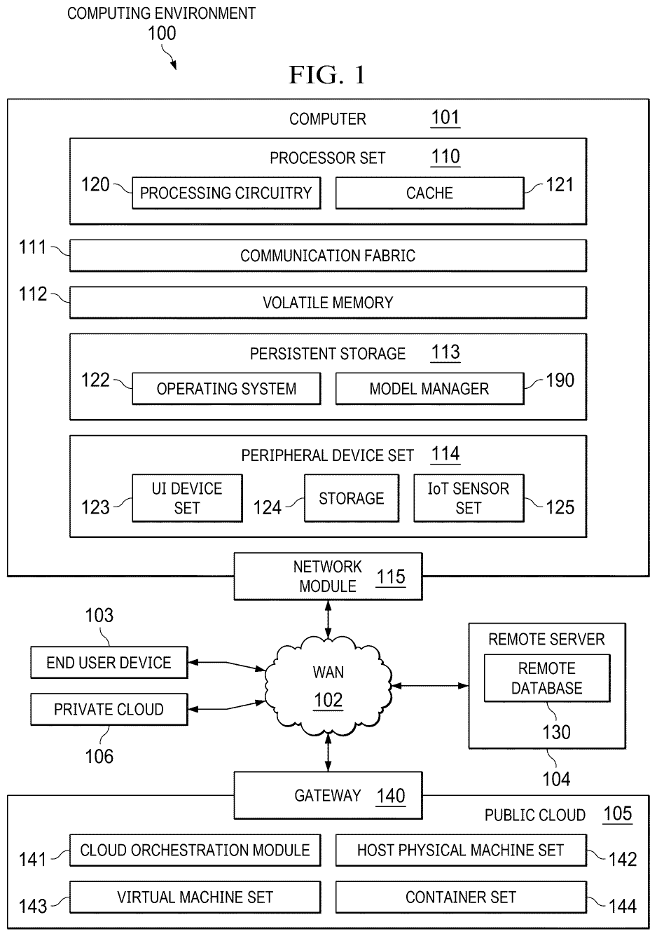

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as model manager 190. In addition to model manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in model manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that selecting the appropriate machine learning for a given task depends on various factors. For example, selecting the appropriate machine learning for a given task depends on nature of the data, the problem type, performance requirements, and available computational resources.

The illustrative embodiments also recognize and take into account that selection of appropriate machine learning model from an extremely rich set of machine learning models. In this case, evaluation of each and every machine learning model using benchmarking data is costly and time-consuming.

Thus, illustrative embodiments of the present invention provide a computer implemented method, computer system, and computer program product for selecting machine learning models for performing tasks. A processor set receives a benchmark dataset comprising a number of benchmark records for evaluating a number of machine learning models. The processor set creates a number of prompts for the number of machine learning models based on a subset of benchmark records from the number of benchmark records. The processor set retrieves a number of outputs for each machine learning model from the number of machine learning models by inputting the number of prompts to each machine learning model from the number of machine learning models. Each output from the number of outputs correspond to a prompt from the number of prompts. The processor set determines a performance score for each machine learning model from the number of machine learning models based on correctness for the number of outputs for each machine learning model from the number of machine learning models using a regression model. The processor set selects a subset of machine learning models from the number of machine learning models to perform a task based on performance scores for the number of machine learning models.

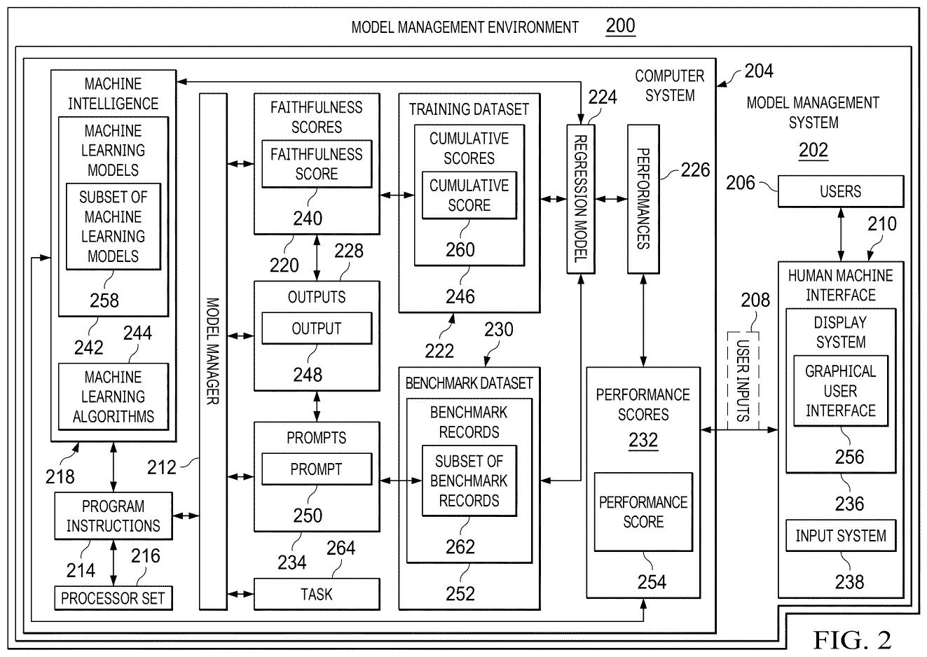

With reference now to FIG. 2, an illustration of a block diagram of a model management environment is depicted in accordance with an illustrative embodiment. In this illustrative example, model management environment 200 includes components that can be implemented in hardware such as the hardware shown in computing environment 100 in FIG. 1.

In this illustrative example, model management system 202 in model management environment 200 can be used for selecting subset of machine learning models 258 from a number of machine learning models 242 for performing task 264. In this illustrative example, task 264 can be any suitable task that involves using artificial intelligence. For example, task 264 can be a natural language processing task or a task associated with Retrieval-Augmented Generation (RAG). In this illustrative example, model management system 202 includes computer system 204 which includes model manager 212. Model manager 212 is located in computer system 204. Model manager 212 may be implemented using model manager 190 in FIG. 1.

Model manager 212 can be implemented in software, hardware, firmware, or a combination thereof. When software is used, the operations performed by model manager 212 can be implemented in program instructions configured to run on hardware, such as a processor unit. When firmware is used, the operations performed by model manager 212 can be implemented in program instructions and data and stored in persistent memory to run on a processor unit. When hardware is employed, the hardware can include circuits that operate to perform the operations in model manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include the number of machine learning models 242 and machine learning algorithms 244. The number of machine learning models 242 is a branch of artificial intelligence (AI) that enables computers to detect patterns and improve performance without direct programming commands. Rather than relying on direct input commands to complete a task, the number of machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems.

The number of machine learning models 242 involves using machine learning algorithms 244 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications. In this illustrative example, the number of machine learning models 242 include subset of machine learning models 258. As depicted, subset of machine learning models 258 are selected by model manager 212 for performing task 264.

In this illustrative example, machine learning algorithms 244 can include supervised machine learning algorithms, semi-supervised machine learning algorithms, and unsupervised machine learning algorithms. Supervised machine learning can train machine learning models using data containing both the inputs and desired outputs. Examples of machine learning algorithms include gradient-boosting algorithms, neural networks, XGBoost, K-means clustering, and Random Forest algorithms.

In this illustrative example, the number of machine learning models 242 can be retrained or updated using new data or outputs generated by the number of machine learning models 242 such that parameters in machine learning algorithms 244 selected for the number of machine learning models 242 can be adjusted to improve accuracy and efficiency of the number of machine learning models 242.

In this illustrative example, model manager 212 can receive benchmark dataset 230 that includes a number of benchmark records 252 for evaluating the number of machine learning models 242 from a number of sources. In this example, the number of benchmark records 252 are data that provide reference points that help measure model performance, accuracy, and reliability. These records ensure that the number of machine learning models 258 are tested against standardized criteria to make their evaluation more objective and comparable across different implementations.

In this illustrative example, model manager 212 creates a number of prompts 234 for the number of machine learning models 242 based on subset of benchmark records 262 from benchmark records 252. In this illustrative example, subset of benchmark records 262 can be stored in an in-memory vector database that runs entirely in memory. In this example, subset of benchmark records 262 from benchmark records 252 can include 5 benchmark records, 10 benchmark records, 20 benchmark records, or any number of benchmark records depending on the resources allocated for model manager 212.

In this example, the number of prompts 234 can be generated manually or automatically using machine intelligence 218. The number of prompts 234 serves as structured inputs designed to assess a model's performance against standardized datasets. In this example, it should be noted that a well-constructed prompt from the number of prompts 234 takes into account the nature of subset of benchmark records 262 and ground truth data associated with subset of benchmark records 262. In this illustrative example, since benchmark records from subset of benchmark records 262 provide examples that serve as the standard for model evaluation, prompts from the number of prompts 234 must be formulated to test the model's ability to retrieve, process, and generate responses that align with the expected outcomes.

For example, in a reading comprehension benchmark, the prompts may involve asking factual questions about a given passage, while in a sentiment classification benchmark, the prompts would ask the model to determine the sentiment of a given text. In this illustrative example, it should be noted that ground truth data associated with subset of benchmark records 262 can be stored as a part of subset of benchmark records 262, or in separate to subset of benchmark records 262.

In this illustrative example, model manager 212 inputs the number of prompts 234 to each machine learning model from the number of machine learning models 242. In this example, the number of machine learning models 242 generates outputs 228 in response to the number of prompts 234. In other words, outputs 228 include a number of outputs generated by each machine learning model from the number of machine learning models 242. In this example, each output from outputs 228 is generated by a machine learning model from the number of machine learning models 242 in response to a prompt from prompts 234. For example, output 248 can be an output generated by a machine learning model from the number of machine learning models 242 in response to prompt 250 from the number of prompts 234.

In this illustrative example, model manager 212 can determine performance scores 232 for the number of machine learning models 242 based on correctness for outputs 228 generated by the number of machine learning models 242. For example, performance score 254 can be a performance score for a machine learning model in the number of machine learning models 242.

In this illustrative example, performance scores 232 can be generated in a number of ways. For example, model manager 212 can compute performance scores 232 by determining faithfulness scores 220 for outputs 228 generated by the number of machine learning models 242 based on correctness of each output from outputs 228. In this illustrative example, the correctness for outputs 228 can be determined using the ground truth associated with subset of benchmark records 262. For example, faithfulness score 240 can be generated based on correctness of output 248 generated by a machine learning model in response to prompt 250.

In this example, faithfulness scores 220 measure how accurately an AI-generated response aligns with the provided ground truths. This is crucial in certain systems such as Retrieval-Augmented Generation (RAG) systems, where the AI must generate responses based on factual references rather than hallucinate or introduce misinformation. In this illustrative example, faithfulness scores 220 can be generated based on correctness of outputs 228 and answer contexts of outputs 228 in a number of ways. For example, faithfulness scores 220 can be generated through n-gram overlap or semantic similarities. In another example, faithfulness scores 220 can be also generated using techniques such as Cosine Similarity or Sentence-BERT. It should be noted that faithfulness scores 220 are just examples of metrics that can be used for computing performance scores 232. In this illustrative example, faithfulness scores 220 can be replaced using any metric dedicated to RAG solution evaluation.

In addition, model manager 212 generates cumulative scores 246 for outputs 228 based on faithfulness scores 220. In this example, a cumulative score from cumulative scores 246 is generated for each output from outputs 228. For example, cumulative score 260 can be generated for output 248.

In this illustrative example, cumulative scores 246 can be determined by obtaining a mean for the cumulative sum of faithfulness scores for each output and faithfulness scores for all outputs precede each output. For example, if 5 benchmark records are included in subset of benchmark records 262 and therefore 5 prompts are generated as the number of prompts 234. In this example, inputting the number of prompts 234 to a machine learning model from the number of machine learning models 242 will result in 5 outputs. A faithfulness score can be generated for each of the 5 outputs.

As depicted, the cumulative scores for the 5 outputs can be generated based on a mean for the cumulative sum of faithfulness scores for each output and faithfulness scores for all outputs precede each output. For example, if faithfulness scores for the 5 outputs for the 5 prompts are “0.1”, “0.2”, “0.3”, “0.4”, and “0.5”, respectively, the cumulative score for the second output can be calculated by (0.1+0.2)/2, which is 0.15. In a similar fashion, the cumulative score for the third output can be calculated by (0.1+0.2+0.3)/3, which is 0.2. In addition, the cumulative score for the fourth output and fifth output can be calculated by (0.1+0.2+0.3+0.4)/4 and (0.1+0.2+0.3+0.4+0.5)/5, which are 0.25 and 0.3, respectively.

In this illustrative example, model manager 212 uses cumulative scores 246 to generate training dataset 222 for training regression model 224. In this illustrative example, regression model 224 is trained by adjusting parameters in function of regression model 224 such that regression model 224 is able to predict cumulative scores for outputs generated by the number of machine learning models 242 when more benchmark records are involved. In other words, regression model 224 is trained by identifying patterns and relationships between outputs 228 and cumulative scores 246 such that regression model 224 is able to develop a mathematical relationship between input features and performance for the number of machine learning models 242 such that regression model 224 is able to predict cumulative scores for other outputs generated by the number of machine learning models 242.

As a result, model manager 212 uses regression model 224 to determine performances 226 for the number of machine learning models 242 by considering all benchmark records from the number of benchmark records 252. In other words, regression model 224 is trained using information associated subset of benchmark records 262 but it is able to predict performance for the number of machine learning models 242 based on all benchmark records from the number of benchmark records 252. In this illustrative example, performances 226 can be representations of cumulative scores generated for the number of machine learning models 242 based on all benchmark records from the number of benchmark records 252.

In this illustrative example, model manager 212 can generate performance scores 232 based on performances 226 for the number of machine learning models 242. In this example, each performance score from performance scores 232 can be a weighted score determined based on performances 226 for the number of machine learning models 242 and additional input variables associated with the number of machine learning models 242. For example, additional input variables associated with the number of machine learning models 242 can include industry benchmark scores, product benchmark scores, inference cost, and inference response time. In this illustrative example, weights for performance scores 232 can be defined manually or automatically using machine intelligence 218.

As a result, model manager 212 can rank the number of machine learning models 242 using performance scores 232 generated for the number of machine learning models 242. Subsequently, model manager 212 can select a number of top ranked machine learning models as subset of machine learning models 258 for performing task 264.

In this illustrative example, users 206 can interact with computer system 204 through user inputs to computer system 204. In this illustrative example, user inputs 208 can be generated by users 206 using human machine interface (HMI) 210. As depicted, human machine interface 210 includes display system 236 and input system 238. Display system 236 is a physical hardware system and includes one or more display devices on which graphical user interface 256 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, users 206 are people that can interact with graphical user interface 256 through user inputs 208 generated by input system 238. Input system 238 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, users 206 can view benchmark dataset 230, prompts 234, outputs 228, faithfulness scores 220, cumulative scores 246, and performance scores 232 through graphical user interface 256.

In one illustrative example, one or more solutions are present that overcome a problem with selecting appropriate machine learning models from a large set of machine learning models for performing a given task without using intensive resources to evaluate the set of machine learning models. As a result, one or more technical solutions may provide an ability to increase the efficiency and performance in computer system 204 by efficient utilization of computational resources and faster execution.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 212 in computer system 204 enables selection of appropriate machine learning models from a large set of machine learning models for performing a given task without using intensive resources to evaluate the set of machine learning models. In particular, model manager 212 transforms computer system 204 into a special purpose computer system as compared to currently available general computer systems that do not have model manager 212.

In the illustrative example, the use of model manager 212 in computer system 204 integrates processes into a practical application for model management. In other words, model manager 212 in computer system 204 is directed to a practical application of processes integrated into model manager 212 in computer system 204 that supports management of machine learning models. In this illustrative example, model manager 212 can efficiently help computer system 204 to increase computer performance and avoid wasting computing resources because efficient management and utilization of computational resources in a computer system provide significant technical advantages.

In other words, selection of an appropriate machine learning model directly affects computational efficiency and resource utilization. Some models demand high processing power, memory, and storage, while others are optimized for lightweight execution on constrained hardware, such as mobile devices, embedded systems, or edge computing environments.

For example, deploying an efficient transformer-based model instead of a large-scale deep learning network can significantly reduce GPU/TPU usage, leading to lower energy consumption and improved inference speeds. By selecting a model that is optimized for the available hardware, organizations can reduce operational costs, power consumption, and hardware wear. This is particularly important in large-scale deployments, such as cloud computing, where inefficient model selection can lead to increased infrastructure costs. In another example, in the field of real-time applications such as autonomous systems or industrial automation, selecting a hardware-friendly model ensures faster decision-making and prevents system delays that could impact safety and efficiency.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, regression model 224 can be part of machine intelligence 218 or implemented separately to machine intelligence 218.

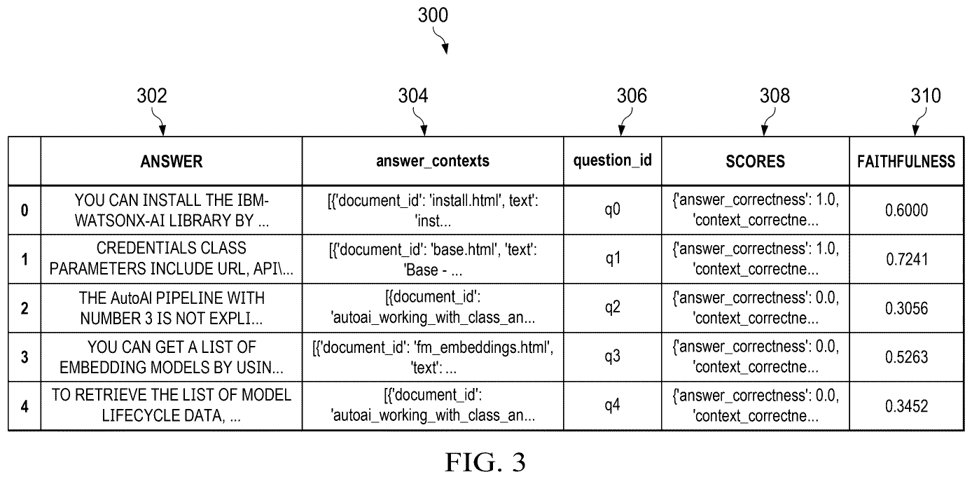

With reference now to FIG. 3, an illustration of a table showing evaluations of outputs generated by machine learning models is shown in accordance with an illustrative embodiment. In this illustrative example, answers from column 302 in table 300 can be an example of outputs 228 in FIG. 2.

In FIG. 3, column 302 in table 300 shows a number of answers generated by a machine learning model in response to different prompts for evaluating performance for the machine learning model. In this illustrative example, the different prompts are represented by question identifiers in column 306. For example, the answer of “you can install the ibm-wastonx-ai library by . . . ” is generated by the machine learning model in response to a question from the prompt represented by question identifier “q0”.

In table 300, column 304 shows contexts extracted from answers shown in column 302. In this example, analysis of different aspects for contexts of answers in column 304 can result in a more reliable method for computing faithfulness scores for answers shown in column 302.

In this illustrative example, column 308 presents correctness scores for answers in column 302. In column 308, a score of “1.0” is used to indicate that the answer generated by the machine learning model is correct while a score of “0.0” is used to indicate that the answer generated by the machine learning model is incorrect. For example, column 308 indicates that answers for questions with question identifiers of “q0” and “q1” are correct while answers for questions with question identifiers of “q2”, “q3”, and “q4” are incorrect.

In this illustrative example, table 300 also contains column 310 that shows faithfulness scores for each answer generated by the machine learning model. As depicted, faithfulness scores measure how accurately an AI-generated response aligns with the provided ground truths. This is crucial in certain systems such as Retrieval-Augmented Generation (RAG) systems, where the AI must generate responses based on factual references rather than hallucinate or introduce misinformation.

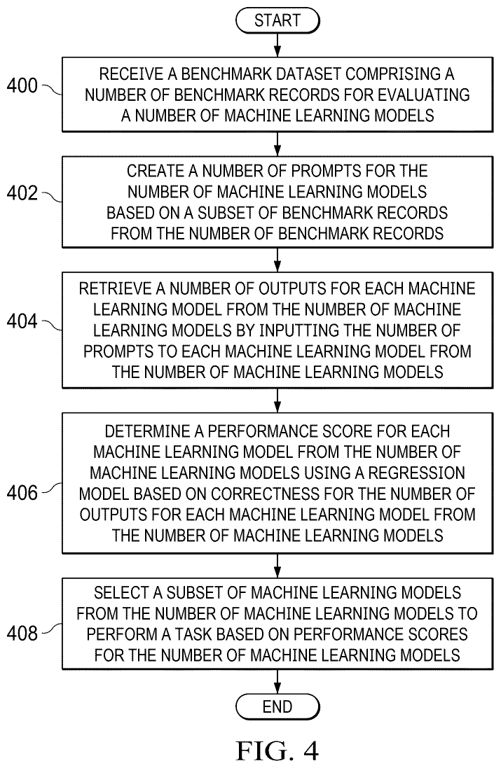

With reference now to FIG. 4, a flowchart illustrating a process for selecting machine learning models for performing tasks is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in model manager 212 in computer system 204 in FIG. 2.

The process begins by receiving a benchmark dataset comprising a number of benchmark records for evaluating a number of machine learning models (step 400). The process creates a number of prompts for the number of machine learning models based on a subset of benchmark records from the number of benchmark records (step 402).

The process retrieves a number of outputs for each machine learning model from the number of machine learning models by inputting the number of prompts to each machine learning model from the number of machine learning models (step 404). In this step, each output from the number of outputs corresponds to a prompt from the number of prompts.

The process determines a performance score for each machine learning model from the number of machine learning models using a regression model based on correctness for the number of outputs for each machine learning model from the number of machine learning models (step 406). The process selects a subset of machine learning models from the number of machine learning models to perform a task based on performance scores for the number of machine learning models (step 408). The process terminates thereafter.

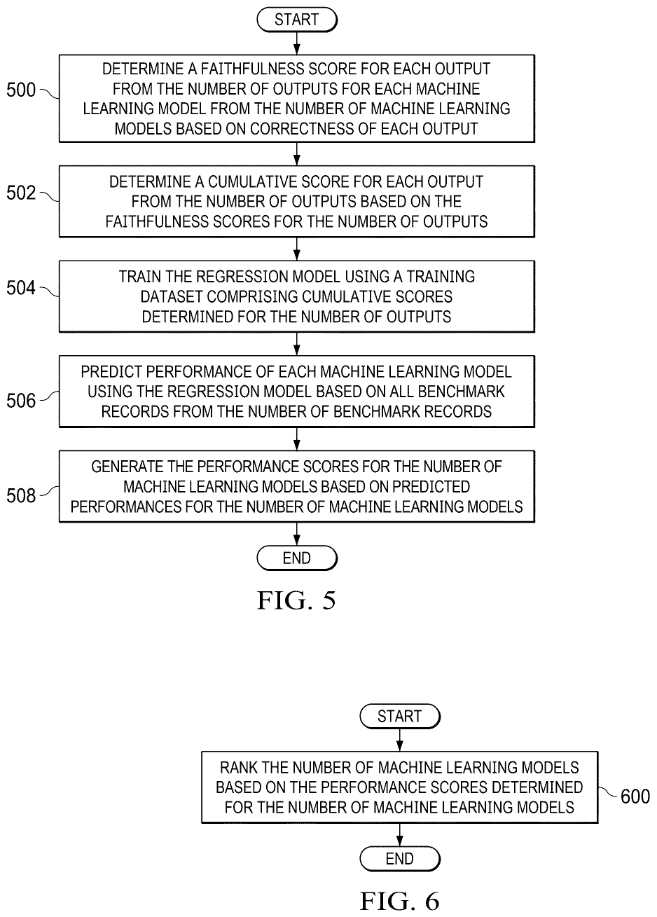

With reference now to FIG. 5, a flowchart illustrating a process for determining performance scores for the number of machine learning models is shown in accordance with an illustrative embodiment. The process in this flowchart is an example of an implementation for step 406 in FIG. 4.

The process begins by determining a faithfulness score for each output from the number of outputs for each machine learning model from the number of machine learning models based on correctness of each output (step 500). The process determines a cumulative score for each output from the number of outputs based on the faithfulness scores for the number of outputs (step 502). The process trains the regression model using a training dataset comprising cumulative scores determined for the number of outputs (step 504). The process predicts performance of each machine learning model using the regression model based on all benchmark records from the number of benchmark records (step 506). The process generates the performance scores for the number of machine learning models based on predicted performances for the number of machine learning models (step 508). The process terminates thereafter.

With reference now to FIG. 6, a flowchart illustrating a process for ranking machine learning models is shown in accordance with an illustrative embodiment. The process in this figure is an example of an additional step that can be performed with the steps in FIG. 4.

The process begins by ranking the number of machine learning models based on the performance scores determined for the number of machine learning models (step 600). The process terminates thereafter.

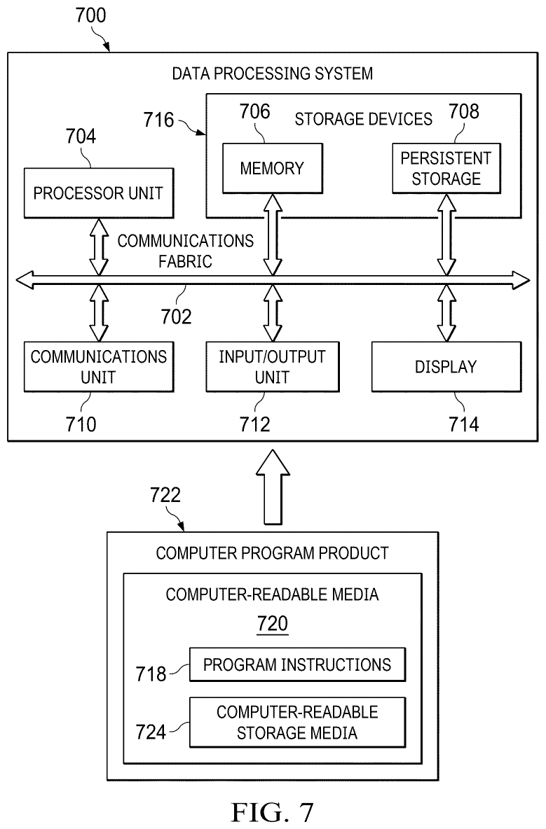

Turning now to FIG. 7, a block diagram of a data processing system is depicted in accordance with an illustrative embodiment. Data processing system 700 can be used to implement computers and computing devices in computing environment 100 in FIG. 1. Data processing system 700 can also be used to implement computer system 204 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 704 can be implemented using one or more heterogeneous processor systems in which a main processor is present with secondary processors on a single chip. As another illustrative example, processor unit 704 can be a symmetric multi-processor system containing multiple processors of the same type on a single chip.

Memory 706 and persistent storage 708 are examples of storage devices 716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 may take various forms, depending on the particular implementation.

For example, persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which may be located in a memory, such as memory 706.

These instructions are referred to as program instructions, computer usable program instructions, or computer-readable program instructions that can be read and executed by a processor in processor unit 704. The program instructions in the different embodiments can be embodied on different physical or computer-readable storage media, such as memory 706 or persistent storage 708.

Program instructions 718 are located in a functional form on computer-readable media 720 that is selectively removable and can be loaded onto or transferred to data processing system 700 for execution by processor unit 704. Program instructions 718 and computer-readable media 720 form computer program product 722 in these illustrative examples. In the illustrative example, computer-readable media 720 is computer-readable storage media 724.

Computer-readable storage media 724 is a physical or tangible storage device used to store program instructions 718 rather than a medium that propagates or transmits program instructions 718. Computer-readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 718 can be transferred to data processing system 700 using a computer-readable signal media. The computer-readable signal media are signals and can be, for example, a propagated data signal containing program instructions 718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program instructions 718 can be located in computer-readable media 720 in the form of a single storage device or system. In another example, program instructions 718 can be located in computer-readable media 720 that is distributed in multiple data processing systems. In other words, some instructions in program instructions 718 can be located in one data processing system while other instructions in program instructions 718 can be located in one data processing system. For example, a portion of program instructions 718 can be located in computer-readable media 720 in a server computer while another portion of program instructions 718 can be located in computer-readable media 720 located in a set of client computers.

The different components illustrated for data processing system 700 are not meant to provide architectural limitations to the manner in which different embodiments can be implemented. In some illustrative examples, one or more of the components may be incorporated in or otherwise form a portion of another component. For example, memory 706, or portions thereof, may be incorporated in processor unit 704 in some illustrative examples. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program instructions 718.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
receiving, by a processor set, a benchmark dataset comprising a number of benchmark records for evaluating a number of machine learning models;
creating, by the processor set, a number of prompts for the number of machine learning models based on a subset of benchmark records from the number of benchmark records;
retrieving, by the processor set, a number of outputs for each machine learning model from the number of machine learning models by inputting the number of prompts to each machine learning model from the number of machine learning models, wherein each output from the number of outputs correspond to a prompt from the number of prompts;
determining, by the processor set using a regression model, a performance score for each machine learning model from the number of machine learning models based on correctness for the number of outputs for each machine learning model from the number of machine learning models; and
selecting, by the processor set, a subset of machine learning models from the number of machine learning models to perform a task based on performance scores for the number of machine learning models.

2. The computer implemented method of claim 1, wherein the determining, by the processor set using a regression model, a performance score for each machine learning model from the number of machine learning models based on correctness for the number of outputs for each machine learning model from the number of machine learning models comprises:
determining, by the processor set, a faithfulness score for each output from the number of outputs for each machine learning model from the number of machine learning models based on correctness of each output;
determining, by the processor set, a cumulative score for each output from the number of outputs based on the faithfulness scores for the number of outputs;
training, by the processor set, the regression model using a training dataset comprising cumulative scores determined for the number of outputs;
predicting, by the processor set using the regression model, performance of each machine learning model based on all benchmark records from the number of benchmark records; and
generating, by the processor set, the performance scores for the number of machine learning models based on predicted performances for the number of machine learning models.

3. The computer implemented method of claim 2, wherein the cumulative score for each output from the number of outputs is determined by obtaining a mean for the cumulative sum of faithfulness scores for each output and faithfulness scores for all outputs precede each output.

4. The computer implemented method of claim 1, further comprising:
ranking, by the processor set, the number of machine learning models based on the performance scores determined for the number of machine learning models.

5. The computer implemented method of claim 1, wherein the subset of benchmark records is stored in an in-memory vector database that runs entirely in memory.

6. The computer implemented method of claim 1, wherein each performance score from the performance scores for the number of machine learning models is a weighted score determined based on predicted performances for a machine learning model and additional input variables associated with the machine learning model.

7. The computer implemented method of claim 1, wherein the subset of machine learning models are selected for performing tasks associated with Retrieval-Augmented Generation (RAG).

8. A computer system comprising:
a processor set;
a set of one or more computer-readable storage media; and
program instructions stored on the set of one or more storage media to cause the processor set to perform operations comprising:
receiving a benchmark dataset comprising a number of benchmark records for evaluating a number of machine learning models;
creating a number of prompts for the number of machine learning models based on a subset of benchmark records from the number of benchmark records;
retrieving a number of outputs for each machine learning model from the number of machine learning models by inputting the number of prompts to each machine learning model from the number of machine learning models, wherein each output from the number of outputs correspond to a prompt from the number of prompts;
determining a performance score for each machine learning model from the number of machine learning models using a regression model based on correctness for the number of outputs for each machine learning model from the number of machine learning models; and
selecting a subset of machine learning models from the number of machine learning models to perform a task based on performance scores for the number of machine learning models.

9. The computer system of claim 8, wherein the determining a performance score for each machine learning model from the number of machine learning models using a regression model based on correctness for the number of outputs for each machine learning model from the number of machine learning models comprises:
determining a faithfulness score for each output from the number of outputs for each machine learning model from the number of machine learning models based on correctness of each output;
determining a cumulative score for each output from the number of outputs based on the faithfulness scores for the number of outputs;
training the regression model using a training dataset comprising cumulative scores determined for the number of outputs;
predicting performance of each machine learning model using the regression model based on all benchmark records from the number of benchmark records; and
generating the performance scores for the number of machine learning models based on predicted performances for the number of machine learning models.

10. The computer system of claim 8, wherein the cumulative score for each output from the number of outputs is determined by obtaining a mean for the cumulative sum of faithfulness scores for each output and faithfulness scores for all outputs precede each output.

11. The computer system of claim 8, wherein the operations further comprise:
ranking the number of machine learning models based on the performance scores determined for the number of machine learning models.

12. The computer system of claim 8, wherein the subset of benchmark records is stored in an in-memory vector database that runs entirely in memory.

13. The computer system of claim 8, wherein each performance score from the performance scores for the number of machine learning models is a weighted score determined based on predicted performances for a machine learning model and additional input variables associated with the machine learning model.

14. The computer system of claim 13, wherein the subset of machine learning models are selected for performing tasks associated with Retrieval-Augmented Generation (RAG).

15. A computer program product comprising:
a set of one or more computer-readable storage media;
program instructions stored in the set of one or more computer-readable storage media to perform operations comprising:
receiving, by a processor set, a benchmark dataset comprising a number of benchmark records for evaluating a number of machine learning models;
creating, by the processor set, a number of prompts for the number of machine learning models based on a subset of benchmark records from the number of benchmark records;
retrieving, by the processor set, a number of outputs for each machine learning model from the number of machine learning models by inputting the number of prompts to each machine learning model from the number of machine learning models, wherein each output from the number of outputs correspond to a prompt from the number of prompts;
determining, by the processor set using a regression model, a performance score for each machine learning model from the number of machine learning models based on correctness for the number of outputs for each machine learning model from the number of machine learning models; and
selecting, by the processor set, a subset of machine learning models from the number of machine learning models to perform a task based on performance scores for the number of machine learning models.

16. The computer program product of claim 15, wherein the determining, by the processor set using a regression model, a performance score for each machine learning model from the number of machine learning models based on correctness for the number of outputs for each machine learning model from the number of machine learning models comprises:
determining, by the processor set, a faithfulness score for each output from the number of outputs for each machine learning model from the number of machine learning models based on correctness of each output;
determining, by the processor set, a cumulative score for each output from the number of outputs based on the faithfulness scores for the number of outputs;
training, by the processor set, the regression model using a training dataset comprising cumulative scores determined for the number of outputs;
predicting, by the processor set using the regression model, performance of each machine learning model based on all benchmark records from the number of benchmark records; and
generating, by the processor set, the performance scores for the number of machine learning models based on predicted performances for the number of machine learning models.

17. The computer program product of claim 16, wherein the cumulative score for each output from the number of outputs is determined by obtaining a mean for the cumulative sum of faithfulness scores for each output and faithfulness scores for all outputs precede each output.

18. The computer program product of claim 15, wherein the operations further comprise:
ranking, by the processor set, the number of machine learning models based on the performance scores determined for the number of machine learning models.

19. The computer program product of claim 15, wherein the subset of benchmark records is stored in an in-memory vector database that runs entirely in memory.

20. The computer program product of claim 15, wherein the subset of machine learning models are selected for performing tasks associated with Retrieval-Augmented Generation (RAG).
